(19) United States
(12) Patent Application Publication
(10) Pub. No.: US 2013/0261873 A1
(43) Pub. Date: Oct. 3, 2013

(54) APPARATUS AND METHOD FOR OBTAINING INFORMATION FROM DRILLED HOLES FOR MINING

(71) Applicants: Annette Bronwyn Pal, South Perth (AU); Eric Nettleton, Kellyville (AU)

(72) Inventors: Annette Bronwyn Pal, South Perth (AU); Eric Nettleton, Kellyville (AU)

(73) Assignees: THE UNIVERSITY OF SYDNEY, Sydney, New South Wales (AU); TECHNOLOGICAL RESOURCES PTY. LIMITED, Melbourne, Victoria (AU)

(21) Appl. No.: 13/989,646

(22) PCT Filed: Nov. 25, 2011
(86) PCT No.: PCT/AU2011/001521

§ 371 Date: May 24, 2013

(30) Foreign Application Priority Data
Nov. 25, 2010 (AU) 2010905223

(51) Int. Cl. E21B 47/00; G01V 3/38; G01V 1/40

(52) U.S. Cl. CPC E21B 47/00; G01V 1/40; G01V 3/38
USPC 701/28; 701/23

(57) ABSTRACT

Apparatus and method for obtaining information from drilled holes for mining A mobile vehicle (11) is operated autonomously to approach a hole (13a) from which information is to be obtained. An onboard perception system (17) detects the exact location of the hole and an onboard sensor (26) is deployed from the vehicle into the hole. Perception system (17) comprises a number of scanners (23) carried by a mounting (24) fitted to the rear of the vehicle. A downhole sensor unit (18) movable along a swinging arm (19) carries downhole sensors selectively lowerable into the hole by operation of cable reels within the unit (18).

### FIELD OF THE INVENTION

This invention relates to mining. It has particular application to open pit mining in which material is removed successively from benches following drilling and blasting.

### BACKGROUND OF THE INVENTION

Conventional open pit mining progressively follows an ore body using drilling and blasting, followed by shovel loading and truck haulage out of a pit. A bench of ore is first drilled to form a pattern of “blast” holes which are subsequently charged with explosives to blast the bench. The blasted material is picked up by shovels, diesel hydraulic excavators or front end haul loaders and placed into haul trucks and transported from the mine pit for processing.

Prior to blasting the drill holes may be examined to assess their physical condition, the depth of any water collected in individual holes and downhole geophysics. This information may be used in setting the explosive charges for blasting and also for grade assessment. At present such examination requires skilled operators to physically visit each hole and operate the necessary inspection and downhole sensing equipment. The present invention enables much of this activity to be automated.

### SUMMARY OF THE INVENTION

According to one aspect the invention may provide apparatus for obtaining information from drilled holes for mining, comprising:

a mobile vehicle operable autonomously to approach a hole from which information is to be obtained;

an onboard perception system to detect the exact location of the hole; and

an onboard sensor deployable from the vehicle into the hole according to the exact hole location detected by the perception system to provide downhole information.

The vehicle may have a navigation system to receive GPS coordinates of drilled holes whereby to control autonomous operation to approach each of the holes in succession.

The perception system may comprise any one or more of laser, camera and radar sensors operable to identify and locate a hole.

The vehicle may be fitted with a sensor deployment system to deploy the sensor into a hole located by the perception system.

The sensor deployment system may comprise an arm movable on the vehicle to position the sensor over the hole for deployment into the hole.

The sensor may be one of a plurality of sensors carried by the vehicle and the deployment system may be operable selectively to deploy individual sensors into the hole.

The vehicle may include a control system operable to cause the vehicle to drive autonomously after detection of the exact hole location by the perception system to a position nearer to or over the detected exact hole location prior to deployment of the sensor equipment.

The sensor or sensors may be operable to measure any one or more of hole depth, depth to water in the hole and downhole geophysics and the vehicle may be fitted with a transmitter for transmitting the downhole information obtained by the sensor to a processing station.

The invention may further provide a method of obtaining information from drilled holes for mining, comprising:

causing an autonomous vehicle fitted with an onboard perception system and a down hole sensor to autonomously approach a hole from which information is to be obtained;

detecting the exact hole location by means of the onboard perception system; and

using the detected exact hole location to deploy the down hole sensor from the vehicle into the hole to obtain downhole information.

### BRIEF DESCRIPTION OF THE DRAWINGS

In order that the invention may be more fully explained one particular autonomous geophysics vehicle and its method of operation will be described with reference to the accompanying drawings, in which:

FIG. 1 is a diagrammatic view of an autonomous vehicle according to the invention; and

FIG. 2 shows the architecture of various systems carried by the vehicle.

### DESCRIPTION OF PREFERRED EMBODIMENTS

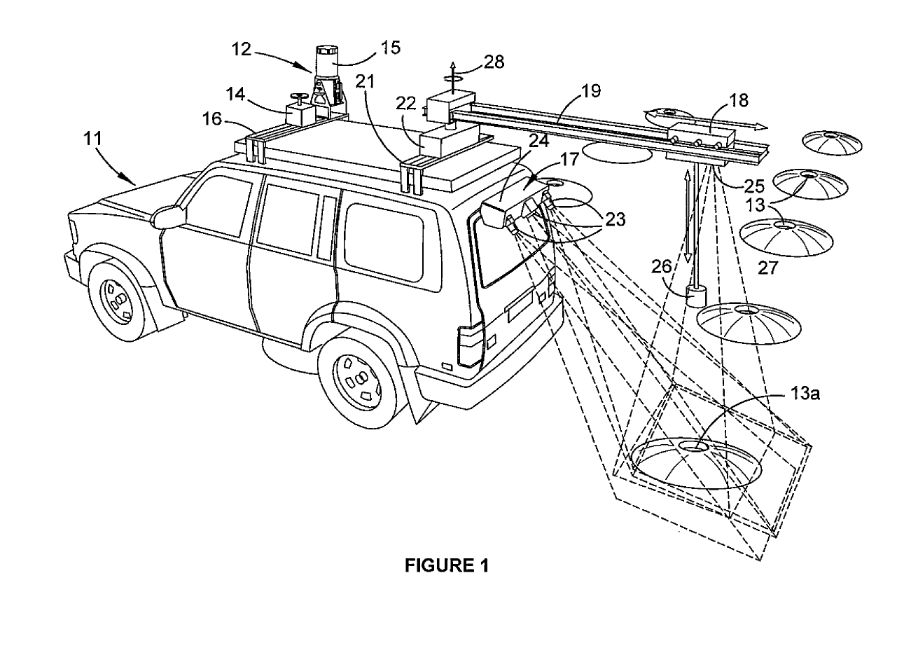

FIG. 1 shows a self-propelled wheeled vehicle 11 which is fitted with a navigation system 12 to enable the vehicle to operate autonomously so as to drive successively to holes 13 from which information is to be obtained. Navigation system 12 includes a navigation sensor unit 14 and a vehicle perception unit 15 mounted on the vehicle by a roof rack 16. Navigation unit 14 may incorporate GPS and inertial navigation sensors of conventional type and the vehicle perception unit 15 may include laser, radar or camera sensors or a combination of such sensors to survey the surrounding terrain and detect obstacles to be avoided. The navigation system 12 enables the vehicle to drive autonomously to a position near a hole using GPS coordinates which may be received from an autonomous drill rig or from a blast lo hole database.

Vehicle 11 is also fitted with a hole detection perception system denoted generally as 17 to detect the exact hole location and a down hole sensor unit 18 housing one or more down hole sensors and movable along a sensor unit mounting arm 19 fitted to a rear part of the vehicle by a roof rack 21 and a pivot mounting 22. Arm 19 is rotatable on mounting 22 about an upright axis 28 to enable the sensor unit 18 to be swung in an arc over the ground surrounding a rear part of the vehicle and to be driven along the arm 19 for accurate location above a hole 13a located by the perception system 17.

Hole location perception system 17 comprises a number of scanners 23 carried by a mounting 24 fitted to the rear of the vehicle. A scanner 25 is also mounted on the sensor unit 18 to enable accurate positioning of the sensor unit 18 above a hole 13a located by the perception system 17. The scanners 23 and 25 may comprise any one or more of laser, radar or camera scanners.

Output from the hole location perception system 17 may also be used to cause the vehicle to move to closer proximity to a located hole for final positioning of the sensor unit on the boom.

Down hole sensor unit 18 carries one or more down hole sensors selectively lowerable by operation of cable reels within unit 18. FIG. 1 shows a down hole sensor 26 being lowered on a cable 27 toward the accurately located hole 13a.

The sensor unit 18, mounting arm 19 and scanner 25 together form a sensor deployment system by which an appropriate sensor 26 can be deployed down the hole 13a which has been accurately located by the hole location perception system 17. Appropriate sensors can be selected according to the required down hole information. This may include hole depth and depth to water data for use in explosive charge setting. This data could be sent to a portable data receiver for use by personnel setting charges. The sensors may also scan the hole to obtain downhole rock properties information which could be used for geological mapping, for example to update an existing geological model and to identify boundaries for mining.

Various kinds of sensors can be employed according to the type of information required. They may for example include sensors operating by laser induced breakdown spectroscopy (LIBS), prompt gamma neutron activation (PGNA), X-ray fluorescence (XRF), natural gamma or infrared radiation, radar and density probing.

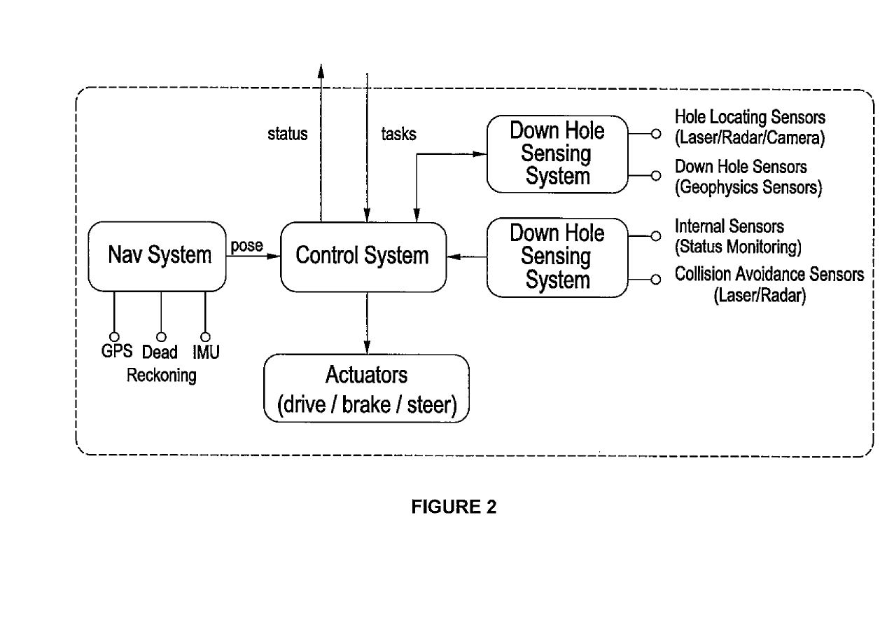

FIG. 2 shows a high level system architecture for the various systems provided in the vehicle as illustrated in FIG. 1. In this figure the term NAV SYSTEM relates to the vehicle navigation/localisation system and the CONTROL SYSTEM looks after the actuation. The VEHICLE PERCEPTION SYSTEM has to sense the world (eg. for obstacles) and includes the perception system 12. The ACTUATORS include sensors that physically move the vehicle and the DOWN HOLE SENSING SYSTEM is the system to detect the hole location and gather down hole data and so includes the hole location perception system 17 and the sensor deployment system.

The vehicle may carry a data processor to process data obtained from the sensors. This data can be stored locally at the vehicle, for example on disc, or it may be transmitted to a processing centre where it may for example update a geological model and/or be transmitted to mine personnel or other autonomously operated equipment carrying out operations for which the downhole information is useful.

The illustrated autonomous vehicle has been advanced by way of example only and many modifications are possible. For example instead of using a swinging boom or arm in the sensor deployment system, the vehicle could instead be moved over the hole to allow sensors to be lowered directly from the vehicle into the hole, although this would require fine vehicle movements for accurate location. It would also be possible to use a sensor deployment system in which a robot mounted on the vehicle is operated robotically so as to select appropriate sensors from a sensor storage holder or rack on the vehicle for successive deployment into the hole. It is to be understood that many such variations and modifications may be made within the scope of the invention and the appended claims.

1. Apparatus for deploying a sensor into a drilled hole for obtaining information from drilled holes, comprising:
a mobile vehicle operable autonomously to approach a hole from which information is to be obtained;
an onboard perception system to detect the exact location of the hole;
a downhole sensor deployable from the vehicle into the hole to provide information; and
a sensor deployment system operable to locate the downhole sensor relative to the hole according to the exact hole location detected by the perception system.

2. Apparatus as claimed in claim 1, wherein the vehicle has a navigation system to receive GPS coordinates of drilled holes whereby to control autonomous operation to approach each of the holes in succession.

3. Apparatus as claimed in claim 1, wherein the perception system comprises any one or more of laser, camera and radar sensors operable to identify and locate a hole.

4. Apparatus as claimed in claim 1, wherein the sensor deployment system is operable to deploy the sensor into a the hole located by the perception system.

5. Apparatus as claimed in claim 4, wherein the sensor deployment system comprises an arm movable on the vehicle to position the sensor over the hole for deployment into the hole.

6. Apparatus as claimed in claim 5, wherein the arm is mounted on the vehicle for swinging movement about an upright pivot axis and the sensor is carried by a sensor unit movable along the arm.

7. Apparatus as claimed in claim 4, wherein the deployment system comprises a robot carried by the vehicle and operable after the perception system locates a hole to pick up the sensor for deployment.

8. Apparatus as claimed in claim 6, wherein the sensor is one of a plurality of sensors carried by the vehicle and the deployment system is operable selectively to deploy individual sensors into the hole.

9. Apparatus as claimed in claim 1, wherein the vehicle includes a control system operable to cause the vehicle to drive autonomously after detection of the exact hole location by the perception system to a position nearer to or over the detected exact hole location prior to deployment of the sensor equipment.

10. Apparatus as claimed in claim 1, wherein the sensor or sensors are operable to measure any one or more of hole depth, depth to water in the hole and downhole rock properties.

11. Apparatus as claimed in claim 1, wherein the vehicle is fitted with a transmitter for transmitting the down hole information obtained by the sensor to a processing station.

12. A method of deploying a sensor into a drilled hole for obtaining information from the drilled holes, comprising:
causing an autonomous vehicle fitted with an onboard hole location perception system and a downhole sensor to autonomously approach a hole from which information is to be obtained;
detecting the exact hole location by means of the onboard perception system; and
using the detected exact hole location to locate the downhole sensor relative to the hole; and deploying the downhole sensor from the vehicle into the hole to obtain downhole information.

13. A method as claimed in claim 12, wherein the autonomous vehicle receives GPs coordinates of drilled holes and is driven autonomously to approach each of the drilled holes in succession.

14. A method as claimed in claim 12, wherein the downhole sensor is selected from a plurality of sensors carried by the vehicle.

15. A method as claimed in claim 12, wherein after the exact hole location is detected by the onboard perception system the vehicle is driven autonomously to a position nearer to or over the detected exact hole location prior to deployment of the downhole sensor.

16. A method as claimed in claim 12, wherein the sensor or sensors are operated to measure any one or more of hole depth, depth to water in the hole and downhole rock properties.

17. A method as claimed in claim 12, wherein the downhole information is transmitted to a processing centre.
